(19) United States
(12) Patent Application Publication
(10) Pub. No.: US 2006/0101023 A1
(43) Pub. Date: May 11, 2006

(54) Universal computing paradigm with single-code base utilizing a flexible distributed computing architecture

(75) Inventors: Ching-Chih Jason Han, Fremont, CA (US); Limin Hu, Fremont, CA (US); Ting-Hu Wu, Fremont, CA (US)

Correspondence Address: DERGOSITS & NOAH LLP, FOUR EMBARCADERO CENTER, SUITE 1450, SAN FRANCISCO, CA, 94111, US

(73) Assignee: Ellie Mae, Inc.

(21) Appl. No.: 10/982,597

(22) Filed: Nov. 5, 2004

(51) Int. Cl. G06F 17/30

(52) U.S. Cl. 707/10

(57) ABSTRACT

An application program for use in a hybrid computing environment comprising standalone, client-server, or Internet use is described. The application is written in a single code base and installed on a client computer that is configured for use as either a standalone or networked computer. Server side components of the application program are installed on a server computer configured to be coupled to client computers over a local or wide area network or over the Internet. Data and file resources utilized by the application program are installed locally on the client computer or on the server computer, or on a device remotely coupled to the network coupling the client and server computers. The application program is installed on the client computer for use as a standalone, client-server, or Internet application, or any combination thereof. At runtime, the user selects the mode of use in which the application program is to be executed.

### FIELD OF THE INVENTION

The present invention relates generally to client-server computer networks, and more specifically, to interactivity among software applications executed on networked computers.

### BACKGROUND OF THE INVENTION

Traditional application programs are complete, self-contained software products that perform a specific function directly for a user. The development of modular programming models, however, has led to the common practice of separating large pieces of software into constituent parts or modules, to allow for easier development and greater maintainability. An extension of modular computing is the client-server programming model in which different modules are executed in different memory spaces, and modules pass instructions and parameters to each other in an interactive manner. In a client-server system, a client module requests a service, and a server module provides the requested service. The requested service could be a data fetch or store operation, an arithmetic or logic function, or any other type of processing function. The execution of client and server modules on different computers that are connected to each other is the basis for client-server network architecture in which dedicated hardware and software platforms perform specific functions. One example is a database management system in which a database application program executed on a client computer performs queries or accesses data from a data server computer.

The increasing use of the Internet as a platform for supporting a wide range of transactional systems has led to the expansion of the client-server programming model to take advantage of this global network. Web-based client-server applications utilize files and resources on the World Wide Web provided by web sites that are served by a web server process on a server computer and accessed by a web browser process running on a client computer. Thus, along with the original standalone programming model and the traditional client-server programming model, the web-based client-server environment has emerged as a popular model for the implementation of application programs.

A notable disadvantage with contemporary application programs is that they are strictly categorized as standalone desktop applications, client/server network applications, or Internet web applications. Each software application typically belongs to one and only one category, and none of them falls into multiple categories.

The strict restriction with regard to application program installation may be acceptable in businesses where use of the application program is static and does not change within the organization. However, it is a disadvantage in dynamic enterprises that require flexible use of computing resources and the adoption of new technologies as they become available. Many small and large-scale enterprises employ a mix of different computer platforms, such as standalone personal computers, networked computers, and wireless computing devices, each of which may also have Internet connectivity. The users of these machines may use the same basic application programs and deal with a common set of data within the company. However, restrictions with regard to how the application programs are installed and used on each computer can limit the interoperability, resource utilization, and maintenance of the application programs.

This limitation is especially true in businesses where common databases are often used and manipulated by different users, each of whom may have different roles within the organization, or where each user may use the data in different ways during the course of their work. For example, in the mortgage industry, loan officers, processors, and brokers usually work in more than one mode of operation. They may work offline, such as when going to a customer's home to collect personal information, and then they may work in a corporate environment so that their files and data can be shared with their co-workers. In addition, they may require access to outside resources or the corporate environment remotely through the public Internet. For this kind of hybrid computing environment, the operability of an application, as well as its collaboration and security features become important issues that need to be addressed. Current application programs that force users to execute the program strictly in accordance with the way that the application was installed on the computer or system do not provide an adequate basis for adapting the program to these different use models.

What is needed, therefore, is an application that can be seamlessly installed and executed in hybrid computing environments including standalone use, client-server use, and web-based Internet application use.

What is further needed is a computing model that facilitates the installation and use of an application program in a combination of different standalone or client-server environments.

### SUMMARY OF THE INVENTION

An application program for use in a hybrid computing environment comprising standalone, client-server, or Internet use is described. The application is written in a single code base and installed on a client computer that is configured for use as either a standalone or networked computer. Server side components of the application program are installed on a server computer configured to be coupled to the client computer over a peer-to-peer network, client-server network or a large-scale network, such as the Internet. Data and file resources utilized by the application program are installed locally on the client computer or on the server computer, or on a device remotely coupled to the network coupling the client and server computers. The application program is installed on the client computer for use as a standalone, client-server, or Internet application, or any combination thereof. At runtime, the user selects the mode of use in which the application program is to be executed. The use of a single code base for the design of the application program allows the same program code to be installed on different client computers regardless of mode of use. Connectivity between the client and server computers and interoperability of the application program components can be automatically established and maintained in a computer network comprising different client computer platforms.

Other objects, features, and advantages of the present invention will be apparent from the accompanying drawings and from the detailed description that follows below.

### BRIEF DESCRIPTION OF THE DRAWINGS

The present invention is illustrated by way of example and not limitation in the figures of the accompanying drawings, in which like references indicate similar elements, and in which:

FIG. 1 illustrates a modular network environment that can be used to implement embodiments of the present invention;

FIG. 2A illustrates a hybrid computing application program that is executed as a standalone program on a single computer, according to one embodiment of the present invention;

FIG. 2B illustrates a hybrid computing application program that is executed as a client-server program in a computer network, according to one embodiment of the present invention;

FIG. 2C illustrates a hybrid computing application program that is executed as a web-based application over an Internet protocol network, according to one embodiment of the present invention;

FIG. 3 is a flowchart that illustrates the installation of the client and server components for a hybrid computing environment, according to one embodiment of the present invention; and

FIG. 4 is a flowchart that illustrates the runtime execution of the client and server components for a hybrid computing environment, according to one embodiment of the present invention.

### DETAILED DESCRIPTION OF THE PREFERRED EMBODIMENT

A hybrid computing framework for application programs executed in standalone or distributed computing environments is described. In the following description, for purposes of explanation, numerous specific details are set forth in order to provide a thorough understanding of the present invention. It will be evident, however, to one of ordinary skill in the art, that the present invention may be practiced without these specific details. In other instances, well-known structures and devices are shown in block diagram form to facilitate explanation. The description of preferred embodiments is not intended to limit the scope of the claims appended hereto.

Aspects of the present invention can be used in a distributed electronic commerce application that includes a client/server network system that links one or more server computers to one or more client computers, as well as server computers to other server computers and client computers to other client computers. The client and server computers may be desktop personal computers, workstation computers, mobile computers, portable computing devices, personal digital assistant (PDA) devices, or any other similar type of computing device. The steps of accessing, downloading, and manipulating the data, as well as other aspects of the present invention are implemented by central processing units (CPU) in the server and client computers executing sequences of instructions stored in a memory. The memory may be a random access memory (RAM), read-only memory (ROM), a persistent store, such as a mass storage device, or any combination of these devices. Execution of the sequences of instructions causes the CPU to perform steps according to embodiments of the present invention.

The present invention involves the execution of an application program on a computer. In general, an application program is a complete, self-contained set of software instructions that are executed on a computer to perform a specific function for the computer user. In a standalone embodiment of the present invention, the application program is stored and executed locally on the computer and local resources, such as processors, memory, input/output, and display devices, are accessed to perform the required functions. The computer may be a personal computer, remote workstation, portable computer, or any other type of standalone computing device. In a networked embodiment, the functionality of the application program is divided between one or more client and server computers that transmit and receive data over a computer network or peer-to-peer link. In a web-based embodiment, the computer network in which the client and server computers operate comprises the Internet.

For purposes of the present invention, the term “hybrid computing environment” refers to the use of an application program executed on a computer in standalone mode, client-server mode, or web-based Internet mode, or any combination thereof.

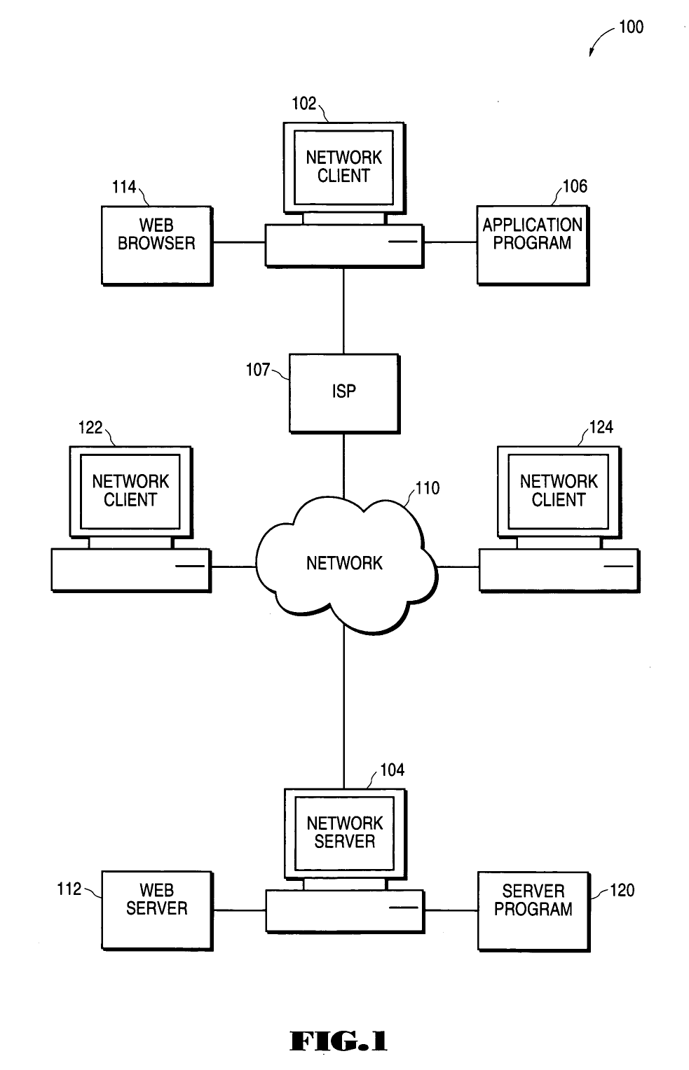

FIG. 1 illustrates an overall computing environment 100 that can be used to implement embodiments of the present application. The actual computing environment in which the inventive application program installation and execution model is implemented may comprise only a portion of system 100. For example, in a most basic implementation, a single computer 102 executes an application program 106 in a standalone environment in which network connectivity from computer 102 is either nonexistent or not utilized.

In a client-server network embodiment, the computer 102, referred to as a “network client” is coupled to a network server computer 104 through a network 110. The network client 102 executes an application program 106, and the network server computer 104 executes a server program 120. For this network environment, the client side application program 106 typically contains solution logic and provides the interface between the user and the rest of the system, while the server program 120 acts as the process that manages shared resources, such as databases, data files, processors, input/output devices, printers, and so on. The network 110 coupling the network client 102 to network server 104 may be a simple peer-to-peer (also referred to as “point-to-point”) connection, a private network (e.g., LAN), or a portion of a corporate network, such as an intranet. Furthermore, the network can be a wireless or a physical (e.g., copper or fiber-based) connection.

For the embodiment in which the network 110 comprises the Internet, the client and server computers communicate over the network using an Internet protocol. In the World Wide Web environment, the network client computer 102 typically accesses the Internet network 110 through an Internet Service Provider (ISP) 107 and executes a web browser program 114 to display data content through web pages. In one embodiment, the web browser program is implemented using Microsoft® Internet Explorer™ browser software, but other web browser programs may also be used. The web browser program 114 may be a separate process resident on the client computer 102, or it may be an embedded web browser that is incorporated within application program 106. For the web-based implementation, the server computer 104 executes a web server process 112 that serves web content in the form of web pages to the client computer 102. The network server 104 also executes a server program 120 that provides the server side processes for use by application program 106. The web browser program 114 is typically used when a markup language (such as HTML), is used to display the information on the client computer. For web services applications, in which a proprietary or non-HTML language is used, the client computer does not necessarily need to execute a web browser to display the content delivered by the server computer.

For the client-server or Internet embodiments, the system 100 may also include other networked servers, such as file download sites, supplemental servers that provide on-line services, data, and/or resources, and the like. It should also be noted that the network illustrated in FIG. 1 can be expanded to include a plurality of client computers, such as client computers 122 and 124, coupled to the server computer and each configured to run the same version of application program 106 in either the same mode or different modes of operation. Network 100 can also be expanded to include a plurality of server computers coupled to the one or more client computers.

As illustrated in FIG. 1, the client computer 102 is configured to execute application program 106. The application program 106 is installed on the client computer 102 to be executed as a standalone application, a client-server network application, or an Internet application. As a standalone application, program 106 is stored and executed locally on the client computer 102. As a networked application, program 106 is executed in conjunction with a server program 120 installed on network server 104. The database, files, or other resources utilized by the application program may be loaded on either the network client 102, network server 104, or both. For Internet applications in which an HTML (Hypertext Markup Language) compatible interface is to be provided, an embedded web browser component 114 may be integrated with or included within the application program. The embedded web browser can be configured to function as a stand-alone web browser to interface with a web server process 112 on server computer 104. In general, however, it is configured to provide an HTML interface for the application program 106.

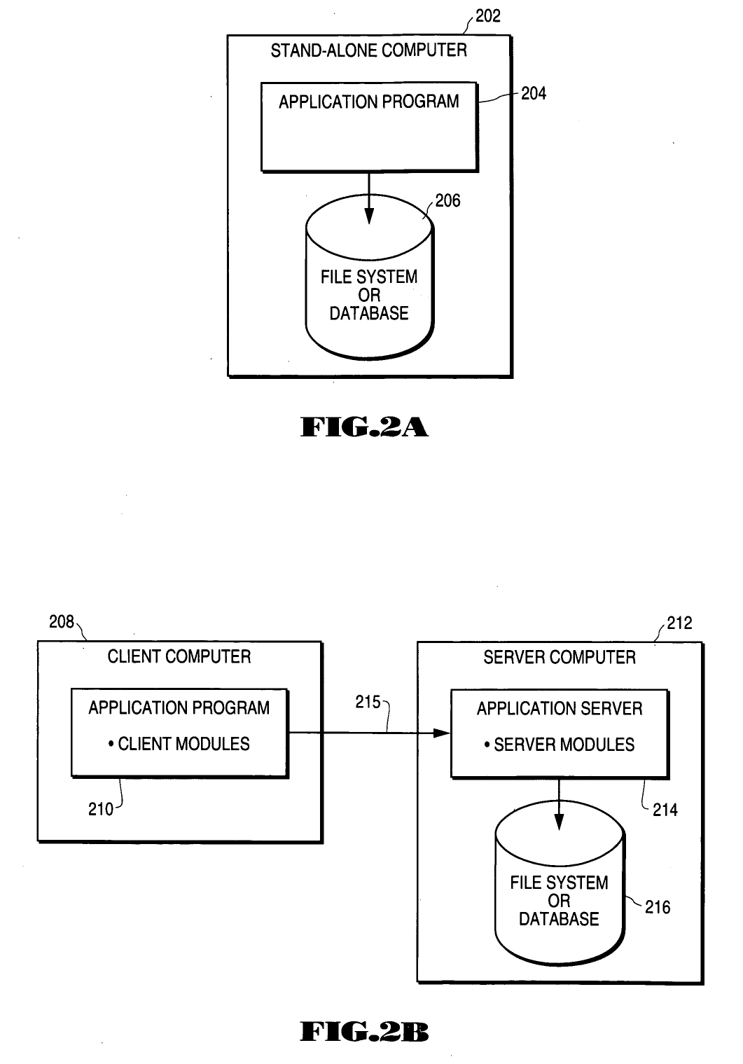

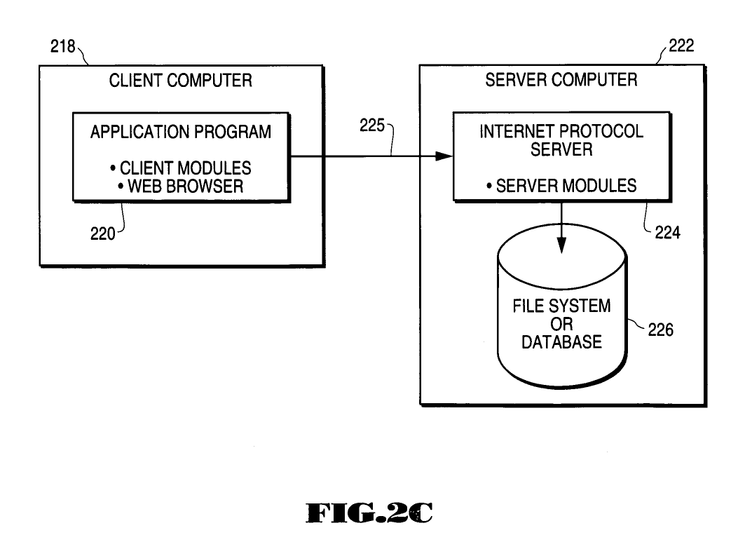

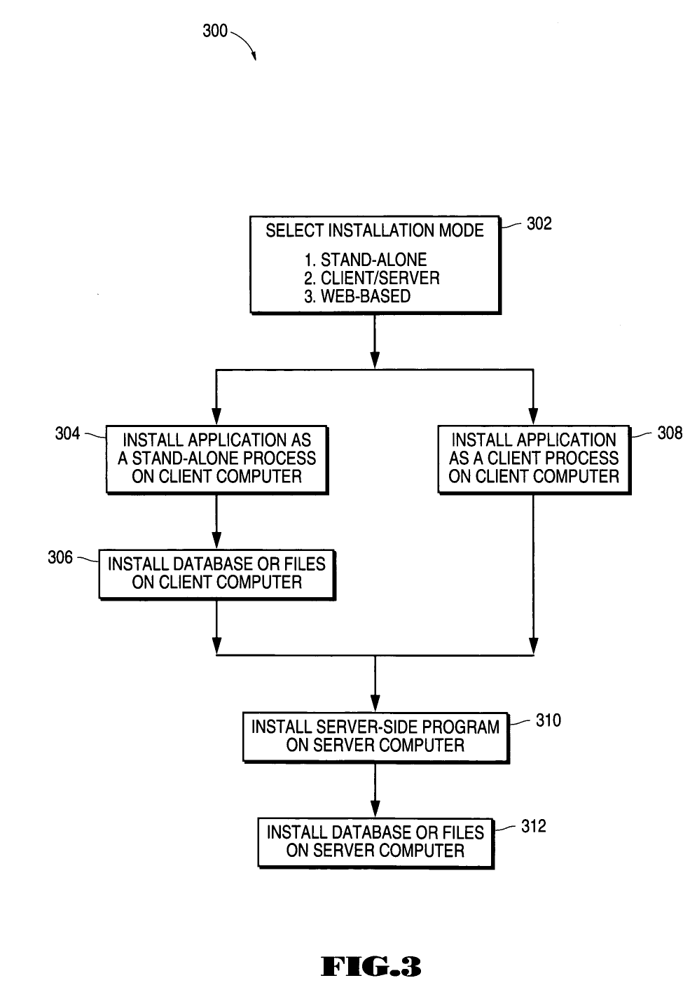

In one embodiment of the present invention, the application program 106 executed by the network client computer 102 features a single code base that allows it to be used in a hybrid computing environment. With little or no modification to the application code, the application program can be executed in either standalone mode, client-server network mode, or web-based (Internet application) mode. FIGS. 2A, 2B, and 2C illustrate each of the three modes in which the application program can be executed.

FIG. 2A is a block diagram that illustrates an application program that is executed as a standalone program on a single computer. As illustrated in FIG. 2A, an application program 204 resides on a standalone computer 202. Application program 204 is configured to be a stand-alone or desktop application that is designed to execute and operate locally on the single computer 202. As such, it contains all of the necessary programming modules required to interact with local resources, such as file system or database 206. The file system or database 206 represents data or data structures that are used by the application program, and may be stored in a memory or disk storage tightly or remotely coupled to the computer 202. As a standalone program, application 204 does not require external access to other computing resources in order to perform its function. The user launches the application program 204 and the program uses the computer's computing power and resources to do its work.

FIG. 2B illustrates an application program that is executed as a client-server program in a computer network, according to one embodiment of the present invention. The application program 210 includes one or more client modules that are executed on a client computer 208. The client computer is coupled to a server computer 212 over network link 215. This link 215 may be a peer-to-peer connection or other type of network link, such as TCP/IP (Transmission Control Protocol/Internet Protocol). In the client-server model, the application program communicates with an application server program 214, which is installed and executed on server computer 212. The application server program 214 serves as a proxy or gateway for the application program 210 and stores or retrieves data to or from the server computer's file system or database 216. In general operation, the application program 210 transmits requests to the server process 214, which services these requests by accessing the appropriate file or data elements stored in database 216. In a typical network implementation, more than one client computer 208 may be coupled to the server computer 212, each of which executes the same or similar versions of the application program.

FIG. 2C illustrates an application program that is executed as a web-based client-server program over the Internet, according to one embodiment of the present invention. In the web application model, the application program 220 is executed by client computer 218 executing one or more client processes and an optional web browser process. The web browser process may be an embedded web browser that is integrated within the application program 220 or it may be a separate executable program resident on the client computer 218. The client processes include modules that handle user input, transmit requests to the server, handle responses back from the server, and display the results on the client computer.

The client computer communicates with server computer 222 over an Internet transport protocol link 225. The Internet protocol may be HTTP (Hypertext Transport Protocol), HTTPS, SOAP (Simple Object Access Protocol), or any other type of Internet access protocol. The application server program 224 acts as the server side process for the application program 220 and provides access to server-side file or data resources 226 in response to requests issued by the client process 220. For the embodiment of the Internet application model illustrated in FIG. 2C, the server computer 222 must be configured to support the Internet protocol used to transmit data over link 225. A web server process may be executed by the server computer 222, but this is not strictly necessary. For example, if the server computer 222 is operating a Microsoft web server, the application server program 224 may be integrated into Microsoft's Internet Information Server (IIS), which is a web server that runs on Windows® NT™ platforms. In this application, a user of the client computer 218 need only point the client program 220 (via the web browser program) to this IIS server.

In a web services embodiment of FIG. 2C, the client computer is not required to execute a web browser program. The necessary components required to display the Internet protocol data may be incorporated in the application program. In a web browser embodiment of FIG. 2C, the client computer executes a web browser. For this embodiment, the client computer is configured to display HTML, or similar markup language content only.

In one embodiment of the present invention, the application program 204, 210, and 220 in each of FIGS. 2A, 2B, and 2C uses a single code base. In this manner, the same code is used to implement the application program, regardless of the computing environment in which it is used. Thus, the same basic application program code can be used to install the application program on a client computer that is used in a hybrid computing environment, with the application program adaptable for use as a standalone, client-server, or Internet application, all on the same computer or group of computers.

In one particular embodiment, the client side application program for the hybrid-computing framework uses the Microsoft .NET remoting mechanism, for all of the three usage models. The Microsoft .NET remoting system allows program objects to interact with one another across application domains and provides client-activated objects or server-activated objects, as well as support mechanisms for these objects. In general, however, any type of system that promotes object interaction across different application domains may be used to implement the single-code base feature of the present invention. Other examples of appropriate remoting systems include remote procedure calls (RPC), Java® Remote Method Invocation (RMI), and the Common Object Request Broker Architecture (CORBA).

The hybrid computing framework provided by the single code base application program allows users of the application program to easily switch among the three modes in a seamless manner. In essence, the only thing that users need to do is to select the operation mode of the application program, and the server computer that is to be connected to, and then log into the server computer. The application program can be configured to automatically direct the users' request to the local file system/database or that on a remote server machine.

Use of the application program in any one of the three hybrid computing environments requires the proper installation of the client, server and database components. FIG. 3 is a flowchart that illustrates the installation of the client and server components for the hybrid computing environment, according to one embodiment of the present invention. In step 302 the installed mode of the application program is selected. The application can be executed as a standalone application, a client/server application, or a web-based (Internet) application. If the application is to be operated in standalone mode, the application is installed on the client computer as a standalone process, step 304. In this mode, the application program must include all components that enable it to operate without any external program calls. Thus, all of the required client and server components must be provided or integrated within the standalone application. For standalone mode, the database, file system, and any other required resources must also be installed on the client computer, step 306. As long as any required network functionality is retained in the application program, this installation represents an unrestricted case in which the application program can be operated in both standalone and networked modes at runtime.

If the application is to be executed only in networked mode (either client/server or web-based), the application program is installed on the client computer as a client process on the client computer, step 308. In this case, the application program cannot be operated in standalone mode since the server side components and local resources are not available on the client computer.

Once the client side process components have been installed (as shown in steps 304, 306, and 308 of FIG. 3), the server side process components are installed. In step 310, the server-side program is installed in the server computer. The databases, file systems, and other resources are then also installed on the server computer or on a device accessible by the server computer, step 312. If the application program is to be used in the web-based mode requiring HTML display on the client computer, it is assumed that a web server program is resident on the server computer and a web browser is resident on the client computer. In a web services embodiment, display on the client computer can be handled by dedicated processes other than a web browser.

In the standalone mode, the user only needs to start the application program and use it as an ordinary desktop application. In the client/server mode, the user needs to connect to the server computer. The server-side application installed in step 310 will then take care of the file system and database accesses on behalf of client application. If the connection is through the Internet, the user can use the client program to connect to the server website, which is setup by integrating the server-side program into the web server.

The use of a single code base, as described above, allows the programming code comprising the application program to be the same regardless of the usage mode of the application program. The same application program code is installed in all possible client computers of a network, even though the usage mode of the application program may be selected differently for each client computer in step 302. This allows the developers of the program to concentrate on the application program logic without being concerned with producing different versions of the program based on different usage modes.

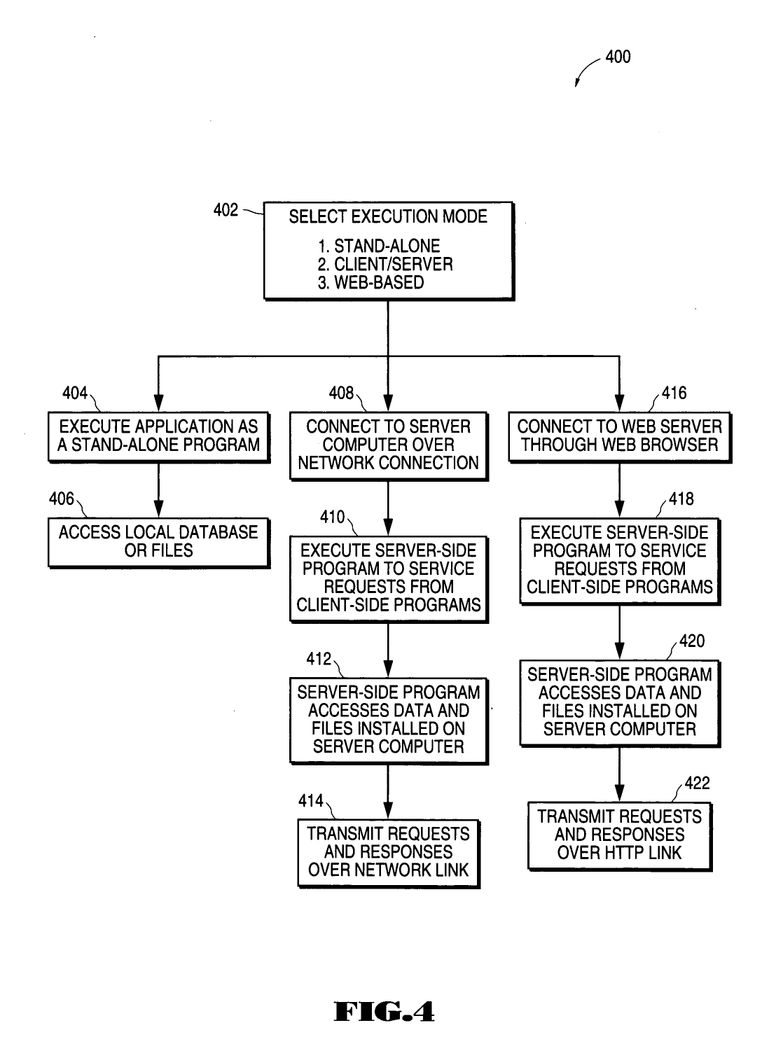

Once the program and data components have been installed, as illustrated by the process shown in FIG. 3, use of the application program is dictated by the runtime execution mode selected by the user. FIG. 4 is a flowchart that illustrates the runtime execution of the client and server components for the hybrid computing environment, according to one embodiment of the present invention. In step 402, the manner in which the application program is to be used is selected. The runtime options available at the execution stage depend upon how the components were installed. If the application was installed as a standalone application with networking capabilities intact and resources available on a remote server, the application can be executed in all three modes—standalone, client-server, or web-based. If the application was installed as a client program only (in step 308), then it can only be executed as a client-server or web-based application.

If the application is to be executed as a standalone program, it is executed on the client computer, step 404. In this case, the program accesses the data, file system, and other resources locally, step 406. If the application was installed as a networked application, and it is to be executed in client-server mode, the client computer opens a connection to the server computer, step 408. Operation of the client side application program causes requests to be made to the server computer, which are serviced by the server-side process, step 410. Typically, the task of servicing client requests involves the server process accessing the data and/or files on the server computer, step 412. The client requests and server responses are transmitted between the client and server computers over the network link coupling the two computers, step 414.

If the application is to be executed as a web-based application, the client computer connects to the web server process of the server computer, step 416. This is typically accomplished by using a web browser resident on the client computer or integrated with the application program executed on the client computer. Client requests are serviced by the server process, step 418, by access of server-side data and/or files by the server process, step 420. For this embodiment, the client requests and server responses are transmitted between the client and server computers over an Internet protocol (e.g., HTTP) link over the portion of the Internet coupling the two computers, step 422.

For the unrestricted installation in which the application program is installed as a standalone application, but with network capability, any of the three modes, or any combination of the three modes may be implemented to execute the application program. For example, the application program executed on the client computer could execute only the client side processes with server side processes servicing the client requests, however the resources could be resident on the client computer, instead of the server computer. As a second example of combined application use (hybrid use), the networking model could rely on both web-based communication as well as network protocols to transmit information. In this case, the peer-to-peer network link may be utilized to transmit sensitive or time-critical information that is unsuitable for Internet traffic.

Under the hybrid computing operating environment provided by the single code base application, various features regarding data integrity and system security can be realized. For example, confidential data regarding products and/or customers can be stored on a server machine, with access strictly restricted to only authorized users. Authentication schemes can be implemented to prevent use or access by unauthorized users through server-based security measures. Furthermore, the hybrid computing model allows the sharing of data and files only among authorized users without the need to duplicate the data on each individual user's computer. This model forces the use of a consistent body of data and files, and a uniform method of accessing these files. Robust version control, read/write privileges and check-in/check-out privileges can also be enforced. The use of a single code base application program prevents the possibility that different versions of the client side application can be developed, which may circumvent the security of the common network resources.

In one embodiment of the present invention, a common graphical user interface design is presented to system users of the application program. This GUI may be displayed as part of an overall network program and displays the usage options available with regard to the application program executed on the client computers. The GUI may include a display area that provides the runtime options selected in step 402 of FIG. 2. That is, the user is prompted to select whether the program is to be used in standalone, client-server, or web-based mode. The user can then select the appropriate usage model depending on his or her computer configuration and needs. Alternatively, the system can be configured to automatically detect which options are available. If the application program was installed as an unrestricted standalone or networked program, then all three usage models can be made available to the user. If, however, the application program were installed only as a networked program, then the standalone option would not be made available to the user.

In the foregoing, a system has been described for providing a single code base application for hybrid computing environments. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. A method for executing an application program, the method comprising:
installing client modules comprising client side components for the application program on a client computer;
storing data to be accessed by the client side components on a first data storage device accessible by the client computer;
installing server modules comprising server side components for the application on a server computer coupled to the client computer;
storing the data to be accessed by the client side components on a second data storage device accessible by the server computer; and
executing the application program as a standalone program or as a client-server program, wherein the client side components transmit requests to the server computer, and wherein the server side components service the client requests by accessing the data.

2. The method of claim 1 wherein the connection coupling the client computer to the server computer comprises a peer-to-peer network link.

3. The method of claim 1 wherein the client modules include server module functionality, enabling the application program to be executed as a standalone program on the client computer.

4. The method of claim 3 wherein the application program is written using a single code base including remote procedure call design rules.

5. The method of claim 4 further comprising the steps of:
installing a web browser process integrated with the client side components on the client computer; and
installing a web server process integrated with the server side components on the server computer.

6. The method of claim 5 wherein the application program is executed as a web-based client/server program.

7. The method of claim 6 wherein the connection coupling the client computer to the server computer comprises the Internet.

8. A method for adapting an application program to be executed among different computer platforms, the method comprising:
installing an application program as a standalone application on a client computer for execution solely on the client computer;
installing the application program as a client program on the client computer for execution in a client/server network coupling the client computer to a server computer;
installing a web browser integrated with the application program on the client computer;
installing a server program for use with the client program on the server computer;
installing a web server integrated with the server program on the server computer; and
storing data used by the application program on both the client and server computers.

9. The method of claim 8 wherein the application program is written using a single code base including remote procedure call design rules.

10. A method of claim 9, wherein upon execution of the application program on the client computer, the method further comprises the step of selecting operation of the application program as a standalone computer program, a client-server computer program, or an Internet protocol based computer program.

11. The method of claim 10 wherein the method further comprises the step of automatically directing client program requests to the data in accordance with the operation selected by a user.

12. The method of claim 8 wherein the network coupling the client computer to the server computer comprises a peer-to-peer network link.

13. The method of claim 8 wherein the network coupling the client computer to the server computer comprises the Internet.

14. A system for executing an application program in a distributed network comprising a plurality of client computers coupled to a server computer, the system comprising:
a first installed application program loaded on a first client computer of the plurality of computers, the first installed application program configured for use as a standalone or client-server application;
a second installed application program loaded on a second client computer of the plurality of computers, the second installed application program being functionally equivalent to the first installed application and configured for use as a standalone or client-server application, wherein the first installed application program and second installed application program are written using a single code base design;
a server side module loaded on the server computer, the server side module including programming components configured to service requests issued by the first installed application program or the second installed application program.

15. The system of claim 14 further comprising data resources accessible to the client and server computers for use by the server side module.

16. The system of claim 15 wherein the client-server application comprises one of a peer-to-peer client-server application or an Internet-based client-server application.

17. The system of claim 14 further comprising a runtime module configured to allow a user of the first client computer to select an operating mode of the first installed application program.

18. The system of claim 14 further comprising a runtime module configured to allow a user of the second client computer to select an operating mode of the second installed application program.
